(19) United States
(12) Patent Application Publication
(10) Pub. No.: US 2003/0095707 A1
(43) Pub. Date: May 22, 2003

(54) Computer vision method and system for blob-based analysis using a probabilistic pramework

(75) Inventors: Antonio J. Colmenarez, Maracaibo (VE); Srinivas Gutta, Yorktown Heights, NY (US); Tomas Brodsky, Croton on Hudson, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/988,946

(22) Filed: Nov. 19, 2001

(51) Int. Cl. G06K 9/34

(52) U.S. Cl. 382/173; 382/225

(57) ABSTRACT

Generally, techniques for analyzing foreground-segmented images are disclosed. The techniques allow clusters to be determined from the foreground-segmented images. New clusters may be added, old clusters removed, and current clusters tracked. A probabilistic framework is used for the analysis of the present invention. A method is disclosed that estimates cluster parameters for one or more clusters determined from an image comprising segmented areas, and evaluates the cluster or clusters in order to determine whether to modify the cluster or clusters. These steps are generally performed until one or more convergence criteria are met. Additionally, clusters can be added, removed, or split during this process. In another aspect of the invention, clusters are tracked during a series of images, and predictions of cluster movements are made.

### FIELD OF THE INVENTION

The present invention relates to computer vision and analysis, and more particularly, to a computer vision method and system for blob-based analysis using a probabilistic framework.

### BACKGROUND OF THE INVENTION

One common computer vision method is called “background-foreground segmentation,” or more simply “foreground segmentation.” In foreground segmentation, foreground objects are determined and highlighted in some manner. One technique for performing foreground segmentation is “background subtraction.”In this scheme, a camera views a background for a predetermined number of images, so that a computer vision system can “learn” the background. Once the background is learned, the computer vision system can then determine changes in the scene by comparing a new image with a representation of the background image. Differences between the two images represent a foreground object. A technique for background subtraction is found in A. Elgammal, D. Harwood, and L. Davis, “Non-parametric Model for Background Subtraction,” Lecture Notes in Comp. Science 1843, 751-767 (2000), the disclosure of which is hereby incorporated by reference.

The foreground object may be described in a number of ways. Generally, a binary technique is used to describe the foreground object. In this technique, pixels assigned to the background are marked as black, while pixels assigned to the foreground are marked as white, or vice versa. Grey scale images may also be used, as can color images. Regardless of the nature of the technique, the foreground objects are marked such that they are distinguishable from the background. When marked as such, the foreground objects tend to look like “blobs,” in the sense that it is hard to determine what the foreground object is.

Nevertheless, these foreground-segmented images can be further analyzed. One analysis tool used on these types of images is called connected components labeling. This tool scans images in order to determine “connected” pixel regions, which are regions of adjacent pixels that share the same set of intensity values. These tools undertake a variety of processes in order to determine how pixels should be grouped together. These tools are discussed, for example, in D. Vernon. “Machine Vision,” Prentice-Hall, 34-36 (1991) and E. Davies, “Machine Vision: Theory, Algorithms and Practicalities,” Academic Press, Chap. 6 (1990), the disclosures of which are hereby incorporated by reference. These and similar tools may be used, for example, to track objects that are passing into, out of, or through a camera view.

While the connected component techniques and other blob-based techniques are practical and useful, there are, however, problems with these techniques. In general, these techniques (1) fail in the presence of noise, (2) treat individual parts of a scene independently, and (3) do not provide means to automatically count the number of blobs present in the scene. A need therefore exists for techniques that overcome these problems while providing adequate analysis of foreground-segmented images.

### SUMMARY OF THE INVENTION

Generally, techniques for analyzing foreground-segmented images are disclosed. The techniques allow clusters to be determined from the foreground-segmented images. New clusters may be added, old clusters removed, and current clusters tracked. A probabilistic framework is used for the analysis of the present invention.

In one aspect of the invention, a method is disclosed that estimates cluster parameters for one or more clusters determined from an image comprising segmented areas, and evaluates the cluster or clusters in order to determine whether to modify the cluster or clusters. These steps are generally performed until one or more convergence criteria are met. Additionally, clusters can be added, removed, or split during this process.

In another aspect of the invention, clusters are tracked during a series of images, such as from a video camera. In yet another aspect of the invention, predictions of cluster movements are made.

In a further aspect of the invention, a system is disclosed that analyzes input images and creates blob information from the input images. The blob information can comprise tracking information, location information, and size information for each blob, and also can comprise the number of blobs present.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary computer vision system operating in accordance with a preferred embodiment of the invention;

FIG. 2 is an exemplary sequence of images illustrating the cluster detection techniques of the present invention;

FIG. 3 is a flow chart describing an exemplary method for initial cluster detection, in accordance with a preferred embodiment of the invention;

FIG. 4 is a flow chart describing an exemplary method for general cluster tracking, in accordance with a preferred embodiment of the invention; and

FIG. 5 is a flow chart describing an exemplary method for specific cluster tracking, used for instance on an overhead camera that views a room, in accordance with a preferred embodiment of the invention.

### DETAILED DESCRIPTION

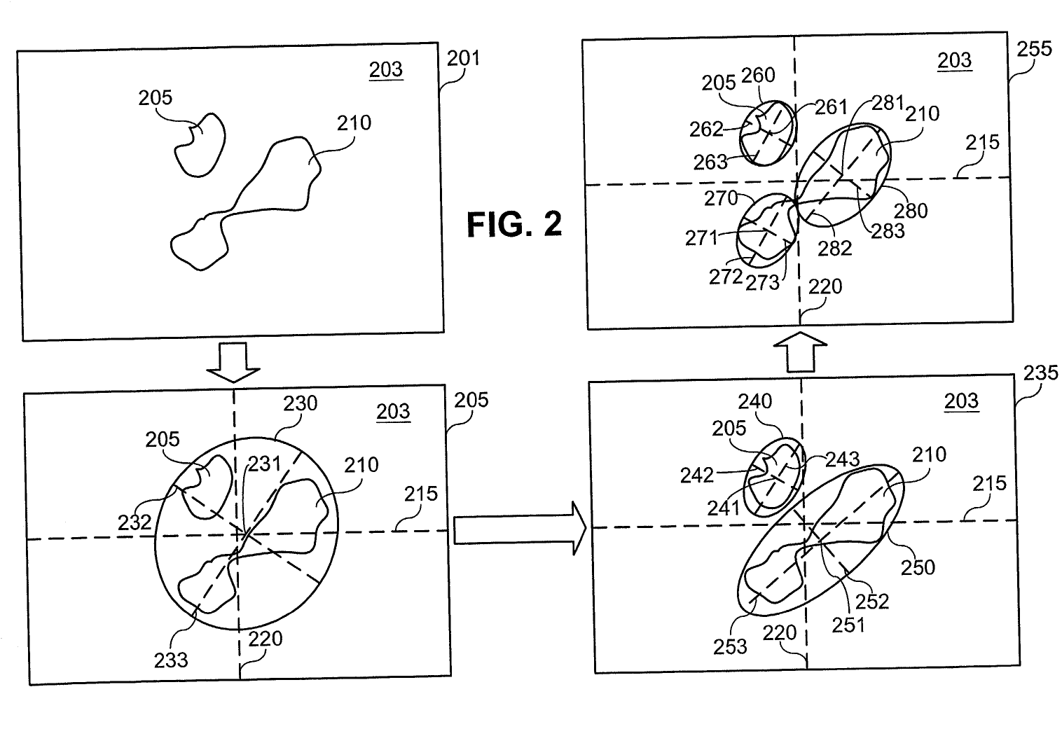

The present invention discloses a system and method for blob-based analysis. The techniques disclosed herein use a probabilistic framework and an iterative process to determine the number, location, and size of blobs in an image. A blob is a number of pixels that are highlighted in an image. Generally, the highlighting occurs through background-foreground segmentation, which is called “foreground segmentation” herein. Clusters are pixels that are grouped together, where the grouping is defined by a shape that is determined to fit a particular group of pixels. Herein, the term “cluster” is used to mean both the shape that is determined to fit a particular group of pixels and the pixels themselves. It should be noted, as shown in more detail in reference to FIG. 2, that one blob may be assigned to multiple clusters and multiple blobs may be assigned to one cluster.

The present invention can also add, remove, and delete clusters. Additionally, clusters can be independently tracked, and tracking information can be output.

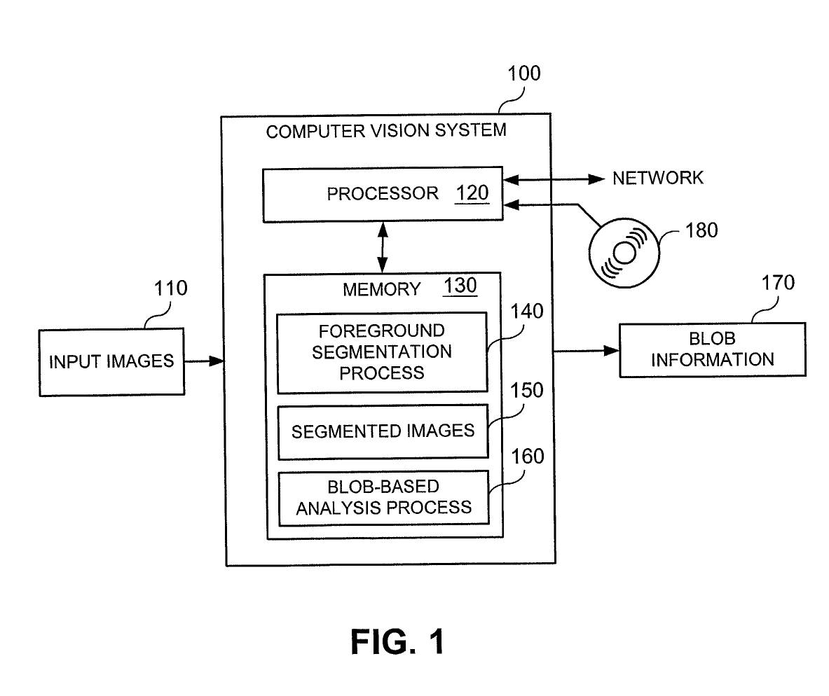

Referring now to FIG. 1, a computer vision system 100 is shown interacting with input images 110, a network, and a Digital Versatile Disk (DVD) 180, and, in this example, producing blob information 170. Computer vision system 100 comprises a processor 120 and a memory 130. Memory 130 comprises a foreground segmentation process 140, segmented images 150, and a blob-based analysis process 160.

Input images 110 generally are a series of images from a digital camera or other digital video input device. Additionally, analog cameras connected to a digital frame-grabber may be used. Foreground segmentation process 140 segments input images 110 into segmented images 150. Segmented images 150 are representations of images 110 and contain areas that are segmented. There are a variety of techniques, well known to those skilled in the art, for foreground segmentation of images. One such technique, as described above, is background subtraction. As is also described above, a technique for background subtraction is disclosed in “Non-parametric Model for Background Subtraction,” the disclosure of which is incorporated by reference above. Another technique that may be used is examining the image for skin tone. Human skin can be found through various techniques, such as the techniques described in Forsyth and Fleck, “Identifying Nude Pictures,” Proc. of the Third IEEE Workshop, Appl. of Computer Vision, 103-108, Dec. 2-4, 1996, the disclosure of which is hereby incorporated by reference.

Once areas are found that should be segmented, the segmented areas are marked differently from other areas of the image. For instance, one technique for representing segmented images is through binary images, in which foreground pixels are marked white while background pixels are marked black or vice versa. Other representations include grey scale images, and there are even representations where color is used. Whatever the representation, what is important is that there is some demarcation to indicate a segmented region of an image.

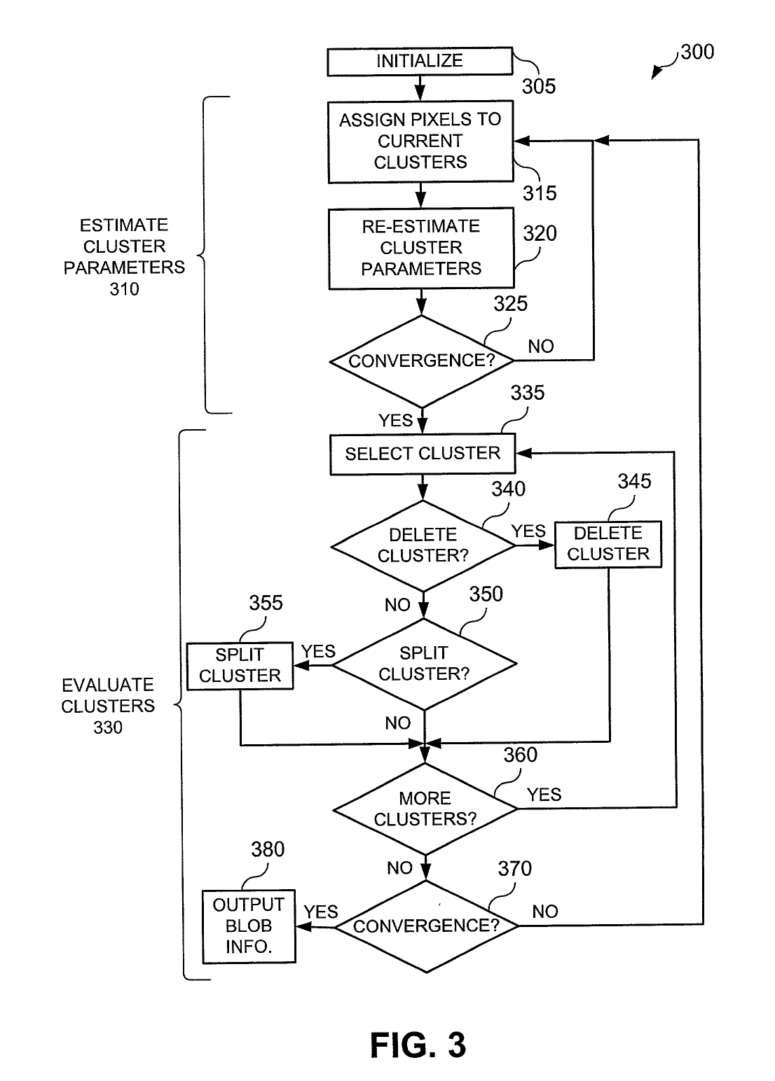

Once segmented images 150 are determined, then the blob-based analysis process 160 is used to analyze the segmented images 150. Blob-based analysis process 160 uses all or some of the methods disclosed in FIGS. 3 through 5 to analyze segmented images 150. The blob-based analysis process 160 examines the input images 110 and can create blob information 170. Blob information 170 provides, for instance, tracking information of blobs, location of blobs, size of blobs, and number of blobs. It should also be noted that blob-based analysis process 160 need not output blob information 170. Instead, blob-based analysis process 160 could output an alarm signal, for instance, if a person walks into a restricted area.

The computer vision system 100 may be embodied as any computing device, such as a personal computer or workstation, containing a processor 120, such as a central processing unit (CPU), and memory 130, such as Random Access Memory (RAM) and Read-Only Memory (ROM). In an alternate embodiment, the computer vision system 100 disclosed herein can be implemented as an application specific integrated circuit (ASIC), for example, as part of a video processing system.

As is known in the art, the methods and apparatus discussed herein may be distributed as an article of manufacture that itself comprises a computer-readable medium having computer-readable code means embodied thereon. The computer-readable program code means is operable, in conjunction with a computer system, to carry out all or some of the steps to perform the methods or create the apparatuses discussed herein. The computer readable medium may be a recordable medium (e.g., floppy disks, hard drives, compact disks such as DVD 180, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk, such as DVD 180.

Memory 130 will configure the processor 120 to implement the methods, steps, and functions disclosed herein. The memory 130 could be distributed or local and the processor 120 could be distributed or singular. The memory 130 could be implemented as an electrical, magnetic or optical memory, or any combination of these or other types of storage devices. The term “memory” should be construed broadly enough to encompass any information able to be read from or written to an address in the addressable space accessed by processor 120. With this definition, information on a network is still within memory 130 of the computer vision system 100 because the processor 120 can retrieve the information from the network.

FIG. 2 is an exemplary sequence of images illustrating the cluster detection techniques of the present invention. In FIG. 2, four image representations 201, 205, 235, and 255 are shown. Each image representation illustrates how the present invention creates clusters in a still image 203. Image 203 is one image from a digital camera. Note that still images are being used for simplicity. A benefit of the present invention is the ease at which the present invention can track objects in images. However, still images are easier to describe. It should also be noted that the process being described in reference to FIG. 2 is basically the method of FIG. 3. FIG. 2 is described before FIG. 3 because FIG. 2 is more visual and easier to understand.

In image 203, there are two blobs 205 and 210, as shown by image representation 201. In image representation 201, it can be seen that a blob-based analysis process, such as blob-based analysis process 160, has added a coordinate system to the image representation 205. This coordinate system comprises X-axis 215 and Y-axis 220. The coordinate system is used to determine locations of clusters and blobs contained therein, and to also provide further information, such as tracking information. Additionally, all blobs have been encircled with ellipse 230, which has its own center 231 and axes 232 and 233. Ellipse 230 is a representation of a cluster of pixels and is also a cluster.

Through the steps of estimating cluster parameters for the ellipse 230 and evaluating the cluster 230, the present invention refines the image representation into the image representation 235. In this representation, two ellipses are chosen to represent blobs 205 and 210. Ellipse 240, which has a center 241 and axes 242 and 243, represents blob 205. Meanwhile, ellipse 250, which has a center 251 and axes 252 and 253, represents blob 210.

After another iteration, the present invention might determine that image representation 255 is the best representation of image 203. In image representation 255, blob 210 is further represented by ellipse 260, which has a center 261 and axes 262 and 263. Blob 210 is represented by ellipses 270 and 280, which have centers 271, 281 and axes 272, 282 and 273, 283, respectively.

Thus, the present invention has determined, in the example of FIG. 2, that there are three clusters. However, these clusters may or may not actually represent three separate entities, such as individuals. If the present invention is used to track clusters, additional steps will likely be needed to observe how the blobs move over a series of images.

Before describing the methods of the present invention, it is also helpful to describe how segmented images may be modeled through a probabilistic framework. The described algorithms of FIGS. 3 through 5 use parametric probability models to represent foreground observations. A fundamental assumption is that the representation of these observations with a reduced number of parameters facilitates the analysis and understanding of the information captured in the images. Additionally, the nature of the statistical analysis of the observed data provides reasonable robustness against errors and noise present in real-life data.

In this probabilistic framework, it is beneficial to use two-dimensional (2D) random processes, X=(x,y) ε [symbol] ², associated with the positions in which foreground pixels are expected to be observed on foreground segmentation images. As a result, the information contained on a set of pixels of a binary image can then be captured by the parameters of the probability distribution of the corresponding random process. For example, a region that depicts the silhouette of an object in an image can be represented by a set of parameters that capture the location and shape of the object.

Binary images, which are two-dimensional arrays of binary pixel values, can be represented with the collection of pixels with non-zero values (i.e., the foreground, in the case of many foreground segmentation methods) through the following equation:

Image={XₖI(Xᵢ)≠0}. [1]

This collection of pixels can be interpreted as observation samples drawn from a two-dimensional random process with some parameterized probability distribution P(X|θ).

Under this representation, random processes can be used to model foreground objects observed in a scene as well as the uncertainties in these observations, such as noise and shape deformations. For example, the image of a sphere can be represented as a cluster of pixels described by a 2D-Gaussian distribution, P(X|θ)=N(X; X₀,Σ), in which the mean X₀ provides location of its center, and the covariance Σ captures information about its size and shape.

Complex objects can be represented with multiple clusters that might or might not be connected to each other. These complex random processes can be written as:

$$P ( X ) = {\sum }_{k = 1}^{M} P ( X \vert {θ}_{k} ) P ( {θ}_{k} ) . \qquad [ 2 ]$$

Note that, given the probability distribution of the foreground pixels, one can reconstruct an approximation of the image by giving non-zero values to all the pixel positions with probability greater that some threshold, and zero values to the rest of the pixels. However, the problem of greatest relevance is that of analyzing the images to obtain the probability models.

The analysis of the input image is then turned into the problem of estimating the parameters of a model by fitting it to the observation samples given by the image. That is, given a binary-segmented image, an algorithm determines the number of clusters and the parameters of each cluster that best describes the non-zero pixels in the image, where the non-zero pixels are the foreground objects.

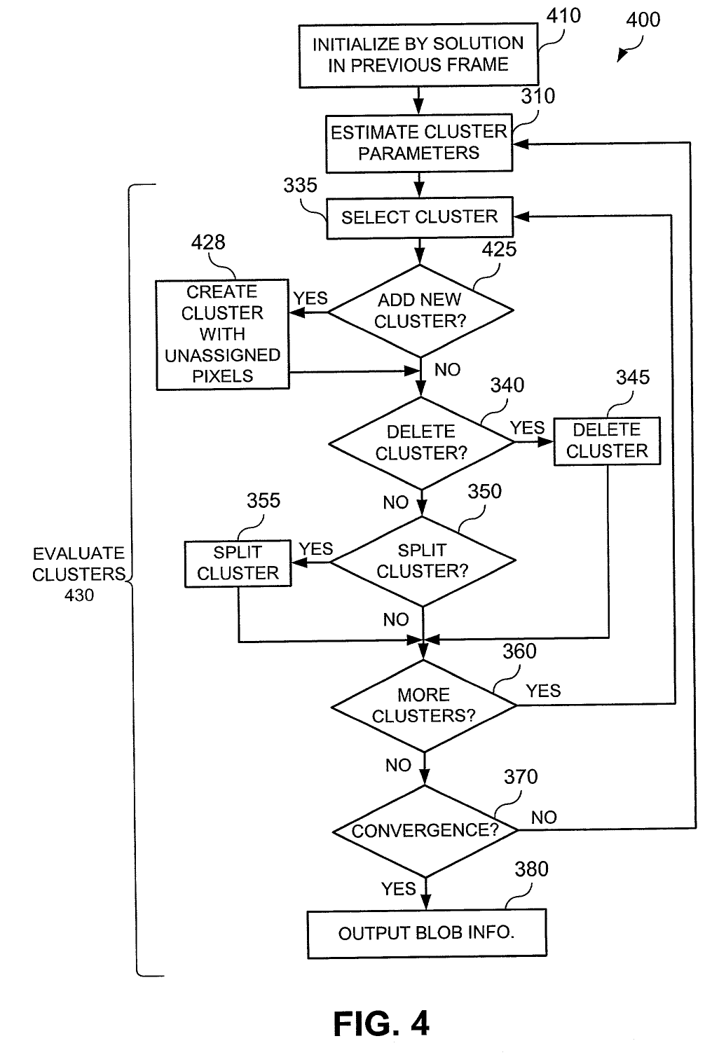

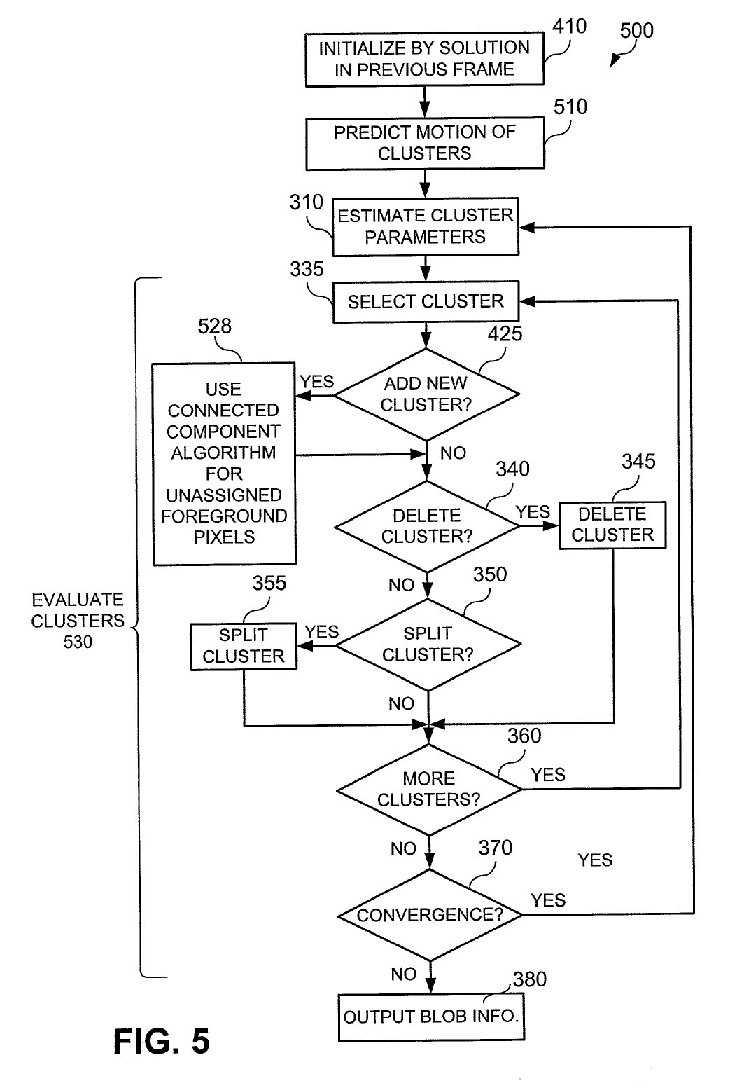

The methods of the present invention are described in the following manner: (1) FIG. 3 describes an initial cluster detection method, which determines clusters from an image; (2) FIG. 4 describes a general cluster tracking method, which is used to track objects over several or many images; and (3) FIG. 5 describes a specialized cluster tracking method, suitable for situations involving, for instance, tracking and counting objects from an camera viewpoint that points down into a room.

Initial Cluster Detection

FIG. 3 is a flow chart describing an exemplary method 300 for initial cluster detection, in accordance with a preferred embodiment of the invention. Method 300 is used by a blob-based analysis process to determine blob information, and method 300 accepts a segmented image for analysis.

Method 300 basically comprises three major steps: initializing 305, estimating cluster parameters 310, and evaluating cluster parameters 330.

Method 300 begins in step 305, when the method initializes. For method 300, this step entails starting with a single ellipse covering the whole image, as shown by image representation 205 of FIG. 2.

In step 310, cluster parameters are estimated. Step 310 is a version of the Expectation-Maximization (EM) algorithm, which is described in more detail in A. Dempster, N. Laird, and D. Rubin, “Maximum Likelihood From Incomplete Data via the EM Algorithm,” J. Roy. Statist. Soc. B 39:1-38 (1977), the disclosure of which is hereby incorporated by reference. In step 315, pixels belonging to foreground segmented portions of an image are assigned to current clusters. For brevity, “pixels belonging to foreground segmented portions of an image” are entitled “foreground pixels” herein. Initially, this means that all foreground pixels are assigned to one cluster.

In step 315, each foreground pixel is assigned to the closest ellipse. Consequently, pixel X is assigned to the ellipse θₖ such that P(X|θₖ) is maximized.

In step 320, the cluster parameters are re-estimated based on the pixels assigned to each cluster. This step estimates the parameters of each θₖ to best fit the foreground pixels assigned to this cluster, θₖ.

In step 325, a test for convergence is performed. If converged (step 325=YES), step 325 is finished. Otherwise (step 325=NO), the method 300 starts again at step 315.

To test for convergence, the following steps are performed. For each cluster θₖ, measure how much the cluster has changed in the last iteration. To measure change, one can use changes in position, size, and orientation. If the changes are small, beneath a predetermined value, the cluster is marked as converged. Overall convergence is achieved when all clusters are marked as converged.

It should be noted that step 325 can also test for a maximum number of iterations. If the maximum number of iterations is reached, the method 300 continues to step 330.

In step 330, the clusters are evaluated. In this step, the clusters may be split or deleted if certain conditions are met. In step 335, a particular cluster is selected. In step 340, it is determined if the selected cluster should be deleted. A cluster is deleted (step 340=YES and step 345) if no or very few pixels are assigned to it. Thus, if there are less than a predetermined number of pixels assigned to the cluster, the cluster is deleted (step 340=YES and step 345). If the cluster is deleted, the method continues in step 360, else the method continues in step 350.

In step 350, it is determined if the selected cluster should be split. A cluster is split (step 350=YES and step 355) if the split condition is satisfied. To evaluate the split condition, the method 300 considers all the pixels assigned to the cluster. For each pixel, evaluate the distance (X−X₀)^{T}π⁻¹(X−X₀), in which the mean X₀ provides location of the center of the ellipse, and the covariance Σ captures information about its size and shape. The outline of the ellipse is the points with distance D₀, typically D₀=3*3=9. The “inside points” are pixels with distances, for example, smaller than 0.25*D₀ and the “outside points” are pixels with distances, for example, larger than 0.75*D₀. Compute the ratio of the number of outside points divided by the number of inside points. If this ratio is larger than a threshold, the ellipse is split (step 355).

In step 360, it is determined if there are more clusters. If there are additional clusters (step 360=YES), then the method 300 again selects another cluster (step 335). If there are no more clusters, the method 300 continues at step 370.

Step 370 performs one or more tests for convergence. First, in step 370, a determination is made as to whether the method is converged. The test for convergence is the same used in step 325, which is as follows. For each cluster ok, measure how much the cluster has changed in the last iteration. To measure change, one can use changes in position, size and orientation. If the changes are small, beneath a predetermined value, the cluster is marked as converged. Overall convergence is achieved when all clusters are marked as converged.

If there is no convergence (step 370=NO), then the method 300 continues again at step 315. It should be noted that step 370 may also determine if a maximum number of iterations have been reached. If the maximum number of iterations have been reached, the method 300 continues in step 380.

If there is convergence (step 370=YES) or, optionally, the maximum number of iterations is reached (step 370=YES), then blob information is output in step 380. The blob information can contain, for example, the locations, sizes, and orientations of all blobs, and also the number of blobs. Alternatively, as discussed previously, blob information need not be output. Instead, information such as a warning or alarm could be output. For instance, if a person enters a restricted area, then the method 300 can output an alarm signal in step 380.

It should be noted that method 300 may determine that there are no clusters suitable for tracking. For example, although not discussed above, clusters may be assigned a minimum dimension. If no cluster meets this dimension, then the image might be considered to have no clusters. This is also the case if there are no foreground segmented areas of an image.

Thus, method 300 provides techniques for determining clusters in an image. Because a probabilistic framework is used, the present invention increases the robustness of the system against noise and errors in the foreground segmentation algorithms.

General Cluster Tracking

General cluster tracking is performed by the exemplary method 400 of FIG. 4. This algorithm assumes a sequence of images and uses the solution for each frame to initialize the estimation process for the next frame. In a typical tracking application, the method 400 starts with the initial cluster detection from the first frame and then proceeds with the cluster tracking for subsequent frames. Many of the steps in method 400 are the same as the steps in method 300. Consequently, only differences will be described herein.

In step 410, the method initializes by the solution obtained in the previous image frame. This provides the current iteration of method 400 with the results of the previous iteration of method 400.

Parameters of clusters are estimated in step 310 as discussed above. This step generally modifies the cluster to track movement of blobs between images.

The step of evaluating clusters, step 430, remains basically the same. For instance, the method 400 can delete clusters (step 340 and 345) and split clusters (steps 350 and 355) as in the previous algorithm 300. However, new clusters may be added for data that was not described by the initial solution. In step 425, a determination as to whether a new cluster should be added is made. If a new cluster should be added (step 425=YES), a new cluster is created and all pixels not assigned to the existing clusters are assigned to the new cluster (step 428). Subsequent iterations will then refine, and split if necessary, this newly added cluster. The additional cluster typically occurs when a new object enters the scene.

Specialized Cluster Tracking

FIG. 5 is a flow chart describing an exemplary method 500 for specific cluster tracking, used for instance on an overhead camera that views a room. In this section, exemplary specific modifications are explained that are used for overhead camera tracking and people counting. The overall scheme is the same as described above, so only differences will be described here.

In step 410, the system is initialized by the solution determined through the previous image frame. However, for each ellipse, the previous motion of an ellipse is used to predict its position in the current iteration. This occurs in step 510. The size and orientation of the predicted ellipse are kept the same, although changes to the size and orientation of the ellipse can be predicted, if desired. The center position is predicted based on previous center positions. For this prediction, a Kalman filter may be used. A reference that describes Kalman filtering is “Applied Optimal Estimation,” Arthur Gelb (Ed.), MIT Press, chapter 4.2 (1974), the disclosure of which is hereby incorporated by reference. Prediction may also be performed through simple linear prediction, as follows:

Pₓ_{₀}(t+1)=x₀(t)+(x₀(t)−X₀(t−1)), [3]

where Pₓ_{₀}(t+1) is the predicted center at time t+1, and X₀(t) and x₀(t−1) are the centers at times t and t−1, respectively.

The step of estimating cluster parameters, step 310, remains basically the same. For real-time video processing with frame rates such as 10 frames per second, it is possible to only perform one or two iterations of each loop, because the tracked objects change slowly.

The step of evaluating clusters (530) remains basically unchanged. The addition of new clusters (step 425 of FIG. 4) is, however, modified in method 500. In particular, if it is determined that a new cluster needs to be added (step 425=YES), all the foreground pixels not assigned to the current clusters are examined. However, instead of assigning all those pixels to a single new cluster, the connected components algorithm is performed on the unassigned pixels (step 528), and one or more new clusters are created for each connected component (step 528). This is beneficial when multiple objects appear at the same time in different parts of the image, as the connected component algorithm will determine whether blobs are connected in a probabilistic sense. Connected component algorithms are described in, for example, D. Vernon. “Machine Vision,” Prentice-Hall, 34-36 (1991) and E. Davies, “Machine Vision: Theory, Algorithms and Practicalities,” Academic Press, Chap. 6 (1990), the disclosures of which have already been incorporated by reference.

The present invention has at least the following advantages: (1) the present invention improves performance by using global information from all the blobs to help in the parameter estimation of each individual one; (2) the present invention increases the robustness of the system against noise and errors in the foreground segmentation algorithms; and (3) the present invention automatically determines the number of blobs in a scene.

While ellipses have been shown as being clusters, other shapes may be used.

It is to be understood that the embodiments and variations shown and described herein are merely illustrative of the principles of this invention and that various modifications may be implemented by those skilled in the art without departing from the scope and spirit of the invention. Additionally, “whereby” clauses in the claims are to be considered non-limiting and merely for explanatory purposes.

What is claimed is:

1. A method comprising:
determining at least one cluster from an image comprising at least one segmented area;
estimating cluster parameters for the at least one cluster; and
evaluating the at least one cluster, whereby the step of evaluating is performed in order to determine whether to modify the at least one cluster.

2. The method of claim 1, wherein:
the step of estimating cluster parameters further comprises the step of estimating cluster parameters for each of the at least one clusters until at least one first convergence criterion is met; and
the step of evaluating cluster parameters further comprises the steps of evaluating cluster parameters for each of the at least one clusters until at least one second convergence criterion is met, and performing the step of estimating if the at least one second convergence criterion is not met.

3. The method of claim 1, wherein:
the step of estimating cluster parameters further comprises the steps of:
assigning pixels from a selected one of the segmented areas to one of the clusters, the step of assigning performed until each pixel from a selected one of the segmented areas has been assigned to a cluster;
re-estimating cluster parameters for each of the clusters; and
determining if at least one convergence criterion is met.

4. The method of claim 1, wherein the step of evaluating cluster parameters further comprises the steps of:
determining whether a selected cluster should be deleted;
deleting the selected cluster when it is determined that the selected cluster should be deleted.

5. The method of claim 4, wherein the step of determining whether a selected cluster should be deleted comprises the steps of:
determining if the selected cluster encompasses a predetermined number of pixels from a segmented area; and
determining that the selected cluster should be deleted when the selected cluster does not encompasses the predetermined number of pixels from a segmented area.

6. The method of claim 1, wherein the step of evaluating cluster parameters further comprises the steps of:
determining whether a selected cluster should be split;
splitting the selected cluster into at least two clusters when it is determined that the selected cluster should be split.

7. The method of claim 6, wherein the step of determining whether a selected cluster should be split comprises the steps of:
determining how many first pixels from a segmented area are within a first region of the cluster;
determining how many second pixels from a segmented area are within a second region of the cluster; and
determining that the selected cluster should be split when a ratio of the second pixels and the first pixels meets a predetermined number.

8. The method of claim 1, wherein:
the step of determining further comprises the step of determining cluster parameters for a previous frame;
the step of evaluating clusters further comprises the steps of:
determining if a new cluster should be added by determining how many pixels in the image are not assigned to a cluster; and
adding the unassigned pixels to a new cluster when the number of pixels that are not assigned to a cluster meets a predetermined value.

9. The method of claim 1, wherein:
the step of determining further comprises the step of determining cluster parameters for a previous frame;
the step of evaluating clusters further comprises the steps of:
determining if a new cluster should be added by determining how many pixels in the image are not assigned to a cluster; and
performing a connected component algorithm on the unassigned pixels in order to add at least one new cluster.

10. The method of claim 1, where in the step of evaluating the at least one cluster comprises adding a new cluster, deleting a current cluster, or splitting a current cluster.

11. The method of claim 1, wherein segmented areas are determined through background-foreground segmentation.

12. The method of claim 11, wherein the background-foreground segmentation comprises background subtraction.

13. The method of claim 11, wherein the segmented areas are marked, wherein the marking is performed through binary marking, whereby background pixels are marked one color and wherein foreground pixels are marked a different color.

14. The method of claim 1, wherein:
each of the clusters is an ellipse, θₖ;
each pixel belonging to a segmented area is a foreground pixel; and
the step of estimating cluster parameters comprises the steps of:
assigning each foreground pixel, X, to each of the ellipses so that a probability that a pixel belongs to a selected ellipse, P(X|θₖ), is maximized; and
estimating the parameters of each ellipse, θₖ, to fit the pixels assigned to a selected ellipse, θₖ within a predetermined error.

15. A system comprising:
a memory that stores computer-readable code; and
a processor operatively coupled to said memory, said processor configured to implement said computer-readable code, said computer-readable code configured to:
determine at least one cluster from an image comprising at least one segmented area;
estimate cluster parameters for the at least one cluster; and
evaluate the at least one cluster, whereby the step of evaluating is performed in order to determine whether to modify the at least one cluster.

16. An article of manufacture comprising:
a computer-readable medium having computer readable code means embodied thereon, said computer-readable program code means comprising:
a step to determine at least one cluster from an image comprising at least one segmented area;
a step to estimate cluster parameters for the at least one cluster; and
a step to evaluate the at least one cluster, whereby the step of evaluating is performed in order to determine whether to modify the at least one cluster.
